(19) United States
(12) Patent Application Publication
(10) Pub. No.: US 2026/0147734 A1
(43) Pub. Date: May 28, 2026

(54) STORING TENSOR DATA USING DIFFERENTIAL SNAPSHOTS

(71) Applicant: Dell Products L.P., Round Rock, TX (US)

(72) Inventors: Qi Bao, Acton, MA (US); Emine Ugur Kaynar Terzioglu, Boston, MA (US); Gaurav Chawla, Austin, TX (US)

(21) Appl. No.: 18/957,019

(22) Filed: Nov. 22, 2024

(51) Int. Cl. G06F 16/18; G06F 16/11; G06F 16/172

(52) U.S. Cl. CPC G06F 16/1873; G06F 16/128; G06F 16/172

(57) ABSTRACT

The technologies described herein are generally directed toward storing tensor data using differential snapshots. For instance, a system can enable performance of operations including storing a tensor as data chunks in a storage device, with a chunk of the data chunks including a first version of the chunk. The operations may further include manipulating a cached copy of the data chunks to change a copy of the chunk from the first version of the chunk to a second version of the chunk, different from the first version. Further, the operations may include copying to the storage device, the second version of the chunk to the data chunks.

### BACKGROUND

Modern systems that implement artificial intelligence (AI)/machine learning (ML) systems may manage multiple storage intensive operations. Tensors are multidimensional arrays that may be used to train AI/ML models and, as workloads evolve, both new and older versions of a tensor may need to be persisted for future use.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include storing, by a system comprising at least one processor, a tensor as data chunks in a storage device, wherein a chunk of the data chunks comprises a first version of the chunk. The method may further include manipulating, by the system, a cached copy of the data chunks to change a copy of the chunk from the first version of the chunk to a second version of the chunk, different from the first version. Further, the method may include copying, by the system, to the storage device, the second version of the chunk to the data chunks. In additional or alternative embodiments, the system includes a model training system that utilizes tensors to train a machine learning model.

In additional or alternative embodiments, the method may further include, before the copying of the second version of the chunk, identifying, by the system, that the second version of the chunk is different from the first version of the chunk, and the copying of the second version of the chunk is based on the identifying. In additional or alternative embodiments, the method may further include receiving, by the system, a request to perform a checkpoint operation on a process of manipulating the data chunks, with the copying of the second version to the data chunks comprises the checkpoint operation, which comprises the change to the copy of the chunk. In additional or alternative embodiments, the operations may further include receiving, by the system, from a raw data processing engine, the tensor, wherein the tensor was generated by a transformation of raw data.

An example system can operate as follows. At least one memory may store computer executable instructions, and at least one processor may be configured to process the computer executable instructions that, when executed by the at least one processor, facilitate performance of operations. The operations may include receiving, from a model training engine, a modified version of a chunk of stored data chunks, wherein the stored data chunks comprise a tensor, and wherein the stored data chunks are referenced by a first version of a manifest that identifies most recently stored versions of the stored data chunks. The operations may further include generating a second version of the manifest that references the modified version of the chunk as a most recently stored version of the chunk.

In additional or alternative embodiments, the operations may further include receiving a request to input the tensor to the model training engine, based on the second version of the manifest, selecting most recently stored versions of the stored data chunks, and based on the most recently stored versions of the stored data chunks, inputting the tensor to the model training engine. In additional or alternative embodiments, the modified version of the chunk of stored data chunks is received from the training engine based on a checkpoint operation. In additional or alternative embodiments, the request to input the tensor to the model training engine comprises a request to input data from the checkpoint operation. In additional or alternative embodiments, the second version of the manifest further references a stored version of another chunk of the stored data chunks as a most recently created version of the other chunk. In additional or alternative embodiments, the version of the manifest comprises a first version of the manifest, and wherein the first version of the manifest and the second version of the manifest are respectively comprised in a first file system file of a file system and a second file system file of the file system.

In additional or alternative embodiments, the second file system file comprises entries referencing the data chunks of the tensor, and wherein the entries comprise references to most recent versions of the data chunks. In additional or alternative embodiments, the data chunks, the first file system file, and the second file system file are stored in a directory of the file system. In additional or alternative embodiments, the operations may further include, based on the second version of the manifest, generating version tracking data for the tensor. In additional or alternative embodiments, the operations may further include, based on a comparison of the first version of the manifest and the second version of the manifest, generating data corresponding to a snapshot differences report for a snapshot of changes to the tensor over time.

An example non-transitory machine-readable medium may include executable instructions that, when executed by at least one processor, facilitate performance of operations. The operations may include receiving a modified version of a data block of stored data blocks, wherein the stored data blocks store portions of a multidimensional array of model training weights representative of a tensor. The operations may further include updating a snapshot record that references a first storage location of the data block to further include a second storage location of the modified data block, resulting in an updated snapshot record. In additional or alternative embodiments, the receiving of the modified version of the data block may include receiving the modified version from a training backend that generated the modified version by transforming source data of the multidimensional array to modify a portion of the multidimensional array corresponding to the data block.

In additional or alternative embodiments, the operations may further include, comparing the snapshot record to the updated snapshot record to identify the modified version of the data block, resulting in a snapshot update of the multidimensional array, and communicating, to a compute node that uses the multidimensional array as training data, the snapshot update of the multidimensional array. In additional or alternative embodiments, the receiving of the modified version of the data block includes receiving the modified version from a compute node that generated the modified version of the data block based on a modification of a model weight stored in the multidimensional array. In additional or alternative embodiments, the operations may further include analyzing the snapshot record and the updated snapshot record, and based on the analyzing, generating a version tracking report for the multidimensional array.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate storing tensor data using differential snapshots, in accordance with one or more embodiments.

FIG. 2 is an architecture diagram of an example system that can facilitate storing tensor data using differential snapshots, in accordance with one or more embodiments.

FIG. 3 is a diagram of an example system that can facilitate storing tensor data using differential snapshots, in accordance with one or more embodiments.

FIG. 4 is a flow diagram of an example system that can facilitate storing tensor data using differential snapshots, in accordance with one or more embodiments.

FIG. 5 is an example code that can facilitate storing tensor data using differential snapshots, in accordance with one or more embodiments.

FIG. 6 depicts a flow diagram representing example operations of an example method that can facilitate storing tensor data using differential snapshots, in accordance with one or more embodiments.

FIG. 7 depicts an example system that can facilitate storing tensor data using differential snapshots, in accordance with one or more embodiments.

FIG. 8 depicts an example non-transitory machine-readable medium that can include executable instructions that, when executed by a processor of a system, can facilitate storing tensor data using differential snapshots, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Generally speaking, one or more embodiments described herein can facilitate storing tensor data using differential snapshots, in accordance with one or more embodiments.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

As mentioned in the background, as workloads evolve, both new and older versions of a tensor may need to be persisted for future use. In response to the need for ongoing storage of changed tensors over time, model developers may simply allocate more storage and computational resources to continually store multiple copies of tensors, as they are changed. Problems resulting from inefficient storage of training data may be aggravated as the use of raw data that includes complex multimedia continues to increase.

As used herein, “tensor” describes a multidimensional array that includes model parameters generated based on processing source/raw data. To enable models to learn intricate patterns in raw data samples, a training dataset may be used multiple times to train the AI model, e.g., in multiple training epochs. One or more embodiments provide a tensor storage that can take tensor snapshots and track differences between snapshots so that only differences in a tensor are stored.

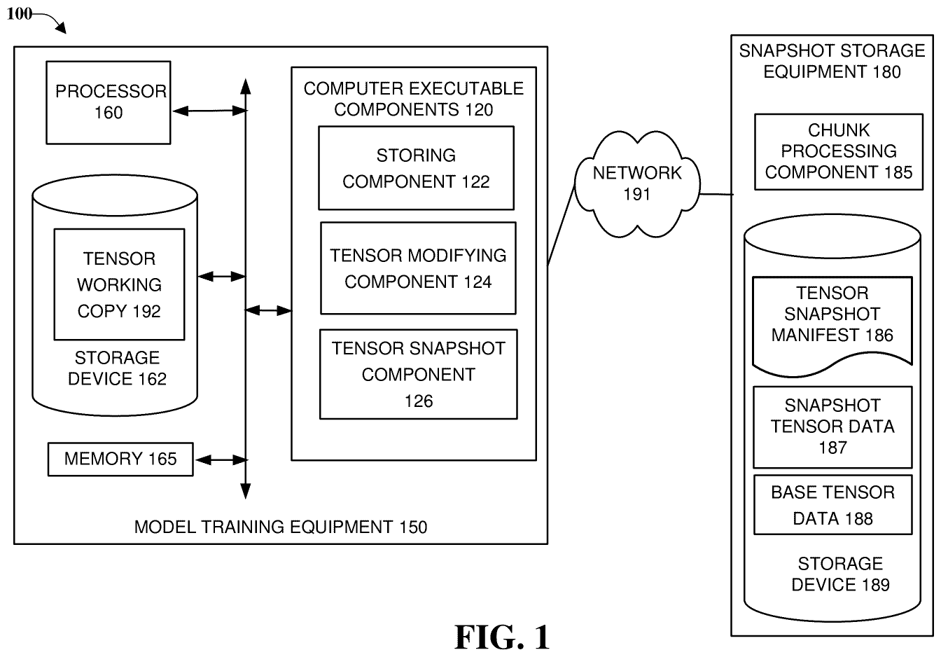

FIG. 1 is an architecture diagram of an example system 100 that can facilitate storing tensor data using differential snapshots, in accordance with one or more embodiments. For purposes of brevity, description of like elements and/or processes employed in other embodiments is omitted. As depicted, system 100 includes model training equipment 150 connected, via network 191, to snapshot storage equipment 180. Snapshot storage equipment 180 includes chunk processing component 185 and storage device 189, which stores tensor snapshot manifest 186, snapshot tensor data 187, and base tensor data 188.

As depicted, model training equipment 150 can include memory 165 that can store one or more computer and/or machine readable, writable, and/or executable components 120 and/or instructions. In embodiments, model training equipment 150 can further include processor 160. In one or more embodiments, computer executable components 120, when executed by processor 160, can facilitate performance of operations defined by the executable component(s) and/or instruction(s). Computer executable components 120 can include storing component 122, tensor modifying component 124, tensor snapshot component 126, and other components described or suggested by different embodiments described herein, that can improve the operation of system 100. Model training equipment 150 may further include storage device 162. In an example, storage device 162 may provide nonvolatile storage of data, data structures, computer executable instructions, and so forth. Storage device 162 is depicted as storing tensor working copy 192.

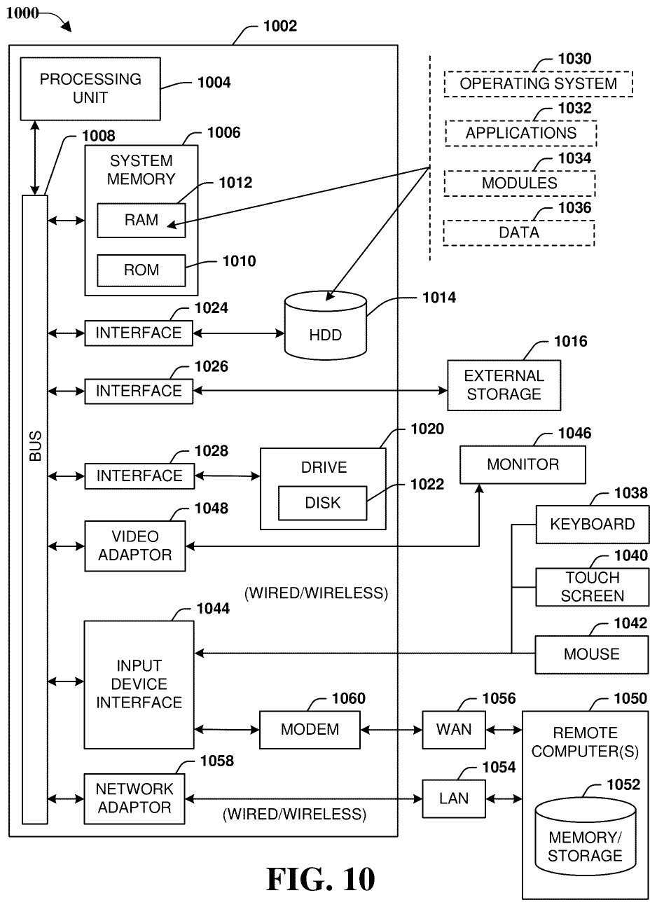

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 191 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP 2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

It is understood that the computer processing systems, computer-implemented methods, apparatus, and computer program products described herein employ computer hardware and/or software to solve problems that are highly technical in nature (e.g., analyzing changes to chunks of tensor information in real-time and caching results based on different factors), that are not abstract and cannot be performed as a set of mental acts by a human. For example, a human, or even a plurality of humans, cannot efficiently handle the rapid storage operations described herein, with a level of accuracy and/or efficiency as the various embodiments described herein.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of storing component 122, which can in some implementations store a tensor as data chunks in a storage device, with a chunk of the data chunks corresponding to a first version of the chunk. For example, in one or more embodiments storing component 122 may store tensor working copy 192 tensor as data chunks in storage device 189, with a chunk of the data chunks corresponding to base tensor data 188 as the first version of the tensor.

In another example, memory 165 can store executable instructions that can facilitate generation of tensor modifying component 124, which can in some implementations manipulate a cached copy of the data chunks to change a copy of the chunk from the first version of the chunk to a second version of the chunk, different from the first version. In one or more embodiments, tensor modifying component 124 may manipulate a chunk corresponding to tensor working copy 192 of the data chunks to change tensor working copy 192 from the first version a second version of tensor working copy 192, different from the first version. As described further the chunk manipulated by tensor modifying component 124 may correspond to the entire tensor or the tensor may be divided across multiple chunks, with the manipulated chunk corresponding to a changed portion of the tensor, and with other chunks of the tensor remaining unchanged.

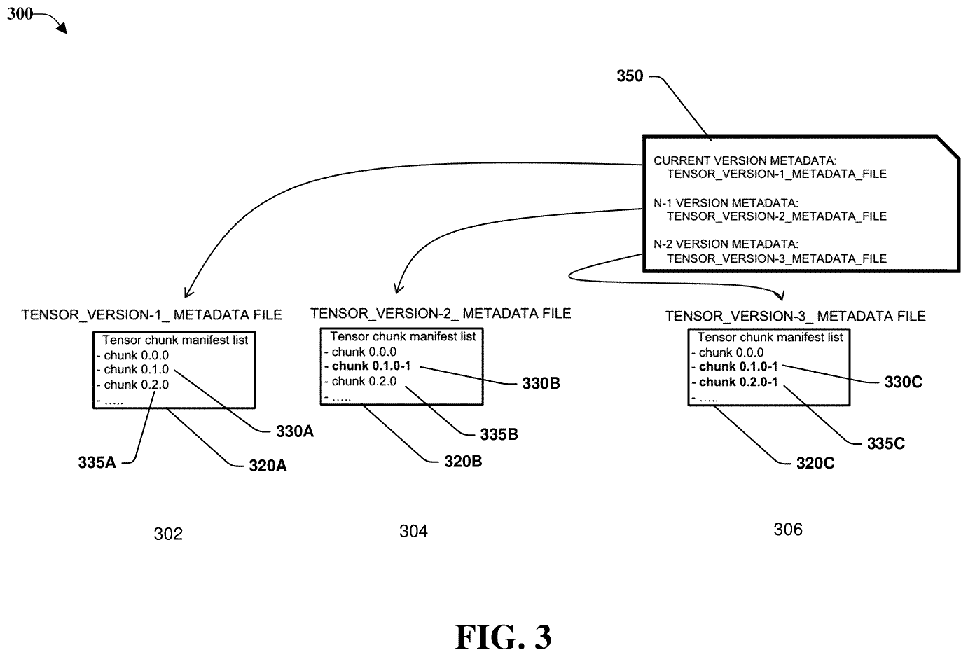

In another example, memory 165 can store executable instructions that can facilitate generation of tensor snapshot component 126, which can in some implementations may copy, by the system, to the storage device, the second version of the chunk to the data chunks. For example, in one or more embodiments, tensor snapshot component 126 may copy to the storage device, the chunk manipulated by tensor modifying component 124 (e.g., the second version of the chunk). As discussed further with FIGS. 3-5 below, tensor snapshot manifest 186 may be updated to map the relationship between snapshot tensor data 187 and base tensor data 188.

Returning to the example where the tensor is divided across multiple chunks, and the manipulated chunk corresponds to one changed chunk of the data chunks of the tensor, tensor snapshot component 126 may copy the manipulated chunk of tensor working copy 192 to storage device 189 as snapshot tensor data 187. In this example, snapshot tensor data 187 corresponds to a differential snapshot that includes modifications to base tensor data 188, e.g., when using differential snapshots, each snapshot includes the new or modified data since the last full snapshot (e.g., base tensor data 188), rather than duplicating the entire dataset. One or more embodiments may thus reduce the use of storage space in storage device 189, make tracking changes more efficient, and reduce the time it takes to store changes to the tensor over time.

As discussed further below, to provide a current version of the tensor, snapshot storage equipment may utilize tensor snapshot manifest 186 to combine base tensor data 188 chunks with one or more of snapshot sensor data 187 chunks. In an implementation, this approach may be used to provide tensor working copy 192 for modifications after the original tensor is generated.

It is appreciated that the embodiments of the subject disclosure depicted in various figures disclosed herein are for illustration only, and as such, the architecture of such embodiments are not limited to the systems, devices, and/or components depicted therein. For example, in some embodiments, model training equipment 150, snapshot storage equipment 180, and other devices discussed herein, can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

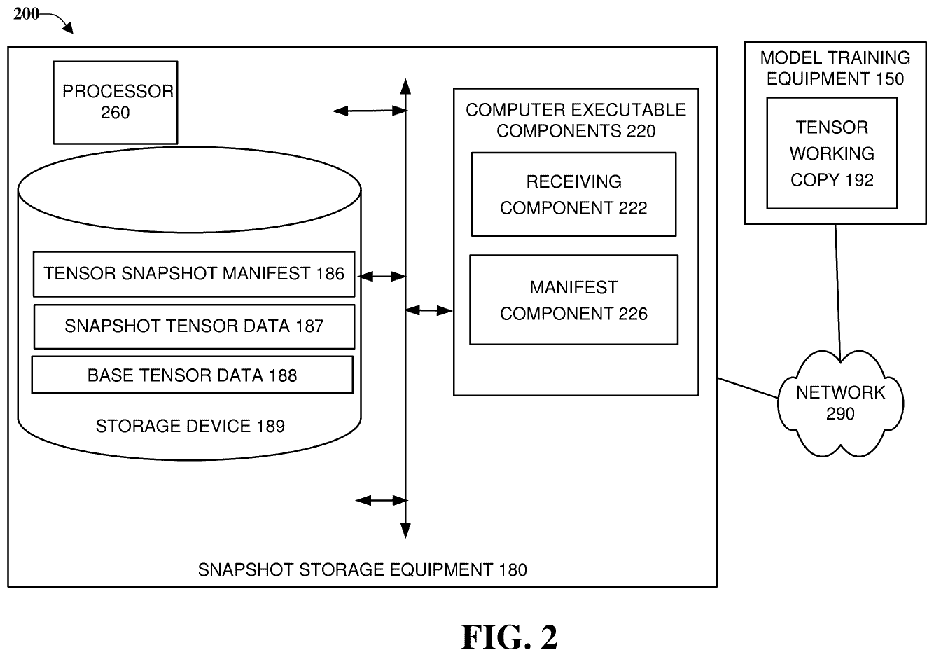

It should be noted that model training equipment 150, snapshot storage equipment 180, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as model training equipment 150. For example, one or more of model training equipment 150, and snapshot storage equipment 180 can all be separate subsystems running in the kernel of a computing device as well as operating on separate network equipment, e.g., as depicted in FIGS. 1 and 2.

FIG. 2 is an architecture diagram of an example system 200 that can facilitate storing tensor data using differential snapshots, in accordance with one or more embodiments. For purposes of brevity, description of like elements and/or processes employed in other embodiments is omitted. As depicted, system 200 includes snapshot storage equipment 180 connected, via network 290, to model training equipment 150. Snapshot storage equipment 180 includes processor 260, memory 265, storage device 189, and computer executable components 220. Storage device 189 stores tensor snapshot manifest 186, snapshot tensor data 187, and base tensor data 188.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include receiving component 222, manifest component 226, and other components described or suggested by different embodiments described herein, e.g., that can improve the operation of system 200, in accordance with one or more embodiments.

In an example implementation of snapshot storage equipment 180, memory 265 can store executable instructions that can facilitate generation of receiving component 222, which in some implementations, may receive, from a model training engine, a modified version of a chunk of stored data chunks, with the stored data chunks corresponding to a tensor, and with the stored data chunks being referenced by a first version of a manifest that identifies most recently stored versions of the stored data chunks. For example, in an embodiment, receiving component 222 may receive, from model training equipment 150, a modified version of a chunk of stored data chunks that correspond to tensor working copy 192, with the changed chunk of tensor working copy 192 being stored as snapshot tensor data 187, e.g., a differential snapshot of changes made since the storage of base tensor data 188.

In an example implementation of snapshot storage equipment 180, memory 265 can further store executable instructions that can facilitate generation of chunk processing component 185, which in some implementations, may store the tensor data in a chunked tensor format that enables parallel input or output of the tensor data, resulting in stored tensor data. In an example, chunk processing component 185 may store base tensor data 188 and one or more snapshot tensor data 187 a chunked tensor format that facilitates parallel input or output of the tensor data, resulting in stored tensor data.

In an example implementation of snapshot storage equipment 180, memory 265 can further store executable instructions that can facilitate generation of manifest component 226, which in some implementations, may generate a second version of the manifest that references the modified version of the chunk as a most recently stored version of the chunk. In an example, manifest component 226 may generate a second version of tensor snapshot manifest 186 that references the snapshot tensor data 187 chunk as being the most recently stored version of that chunk. In one or more embodiments, instead of modifying a single tensor snapshot manifest 186, multiple copies (e.g., versions) of the tensor snapshot manifest 186 may be generated and stored in storage device 189. In some implementations, these versions may be compared to provide version tracking and further improve the efficiency of snapshot storage and retrieval.

FIG. 3 is a diagram of an example system 300 that can facilitate storing tensor data using differential snapshots, in accordance with one or more embodiments. For purposes of brevity, description of like elements and/or processes employed in other embodiments is omitted. Three versions of a tensor manifest entries 330A-C (labeled tensor metadata file) are depicted to illustrate how one or more embodiments may track and store tensor snapshots. Manifest versions 320A-C respectively include manifest entries 330A-C referencing a first chunk of the tensor, and manifest entries 335A-C referencing a second chunk of the tensor. Tensor manifest format 350 illustrates the format of Manifest versions 320A-C. Manifest format 350 is included to describe how entries are arranged in tensor snapshot manifest 186.

In an example, at 302 manifest version 320A corresponds to an initial manifest that was created upon the generation of base tensor data 188. In this manifest three chunks are listed, with each corresponding to a stored portion of base tensor data 188. As described further below, these manifest entries (e.g., manifest entries 330A, 335A) may list out storage locations and other information about particular chunks, e.g., chunk 0.1.0 and 0.2.0, respectively.

At 304, an updated version of chunk 0.1.0 is received and labeled 0.1.0-1. This version may be a manipulated chunk portion of tensor working copy 192 provided by model training equipment 150. In response to the receipt of snapshot tensor data 187, a new version of the tensor manifest may be generated and stored (e.g., manifest version 320B generated from manifest version 330A), with modified manifest entry 330B being included. In an implementation, manifest entry 330B includes a reference to the storage location of chunk 0.1.0-1. In this example, no new versions of chunk 0.2.0 is received, so manifest entry 335B is not changed from manifest entry 330A.

At 306, an updated version of chunk 0.2.0 is received and labeled 0.2.0-1. This version may be a different manipulated chunk portion of tensor working copy 192 provided by model training equipment 150. In response to the receipt of snapshot tensor data 187, a new version of the tensor manifest may be generated and stored (e.g., manifest version 320C generated from manifest version 330B), with modified manifest entry 335C being included. In an implementation, manifest entry 335C includes a reference to the storage location of chunk 0.2.0-1. In this example, no new versions of chunk 0.1.0 is received, so manifest entry 330C is not changed from manifest entry 330B.

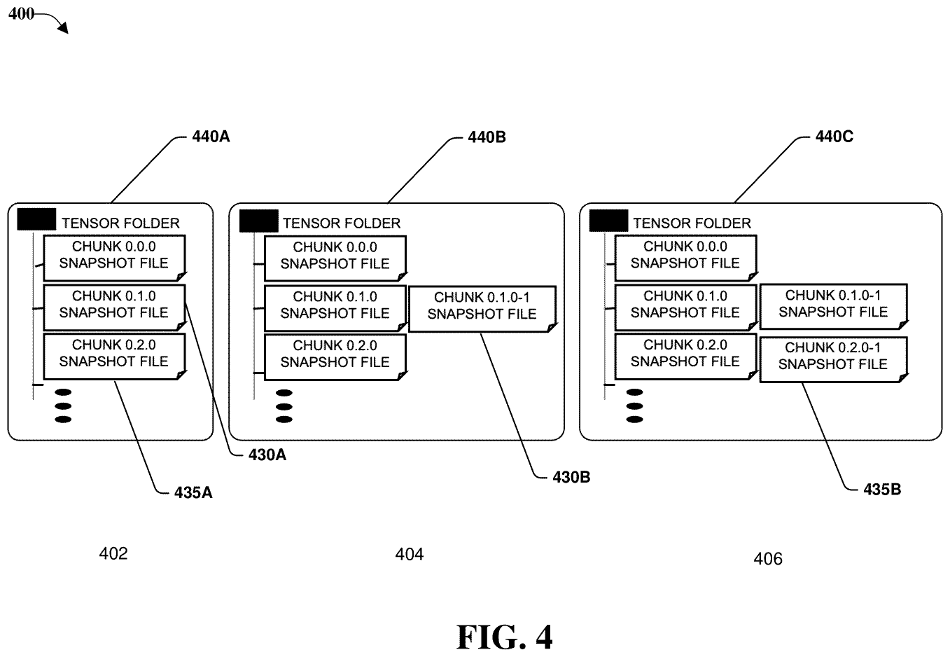

FIG. 4 is a flow diagram of an example system 400 that can facilitate storing tensor data using differential snapshots, in accordance with one or more embodiments. For purposes of brevity, description of like elements and/or processes employed in other embodiments is omitted. Tensor folder instances 440A-C represent instances of a file folder in a file system that are respectively referenced by manifest versions 320A-C discussed with FIG. 3. Tensor folder instances 440A-C include representations of snapshot files 430A-B storing snapshot data for chunk 0.1.0, and 435A-B storing snapshot data for chunk 0.2.0.

In an example, at 402, manifest version 320A corresponds to the storage of snapshot files for chunks 0.0.0, 0.1.0 (snapshot file 430A), and 0.2.0 (snapshot file 435A) in tensor folder instance 440A. As noted with FIG. 3, manifest version 320A may be considered an example of an initial tensor snapshot manifest 186 that was created to store a chunked base tensor data 188 in a tensor folder at snapshot storage equipment 180.

At 404, an updated version of chunk 0.1.0 is received by receiving component 222 of snapshot storage equipment 180. This chunk is stored on storage device 189 as CHUNK 0.1.0-1 SNAPSHOT FILE (snapshot file 430B), in the tensor folder instance 440B. Upon storage of the chunk 0.1.0-1, manifest component 226 generates a new 304 version of tensor snapshot manifest 186 to reference the new snapshot tensor data 187 stored in the tensor folder instance 440B. In this example, no new versions of chunks 0.0.0 or 0.2.0 are received, so in the new manifest version 320B of tensor snapshot manifest 186 the corresponding manifest entries of manifest version 320A are not changed for these references.

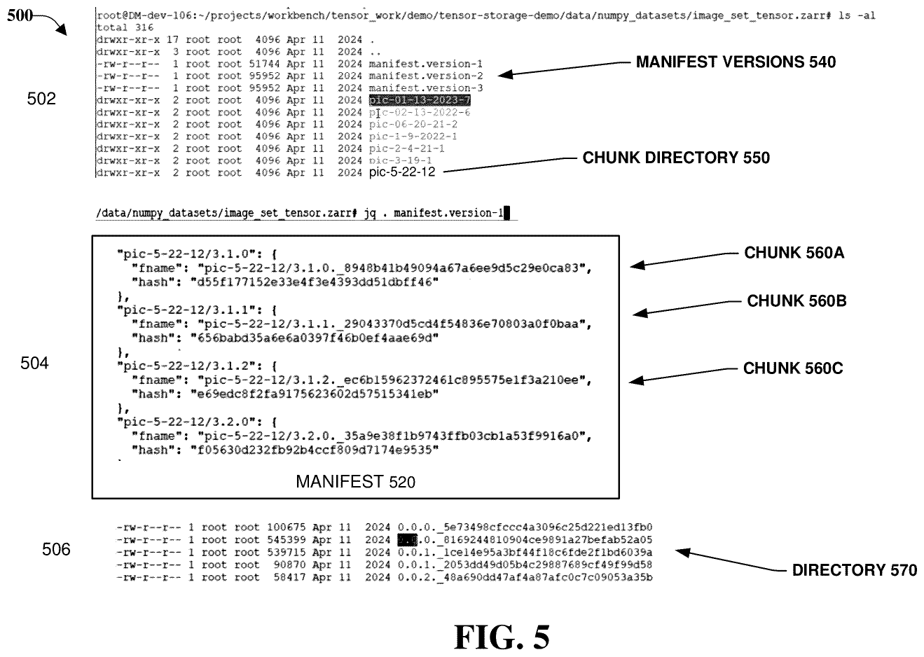

At 406, an updated version of chunk 0.2.0 is received and labeled 0.2.0-1 for storage as CHUNK 0.2.0-1_SNAPSHOT FILE (435B). This version may be a different manipulated chunk portion of tensor working copy 192 provided by model training equipment 150. In response to the receipt of snapshot tensor data 187, a new version of the tensor manifest may be generated and stored (e.g., manifest version 320C generated from manifest version 320B), with modified manifest entry 335C being included to reference the new snapshot file for chunk 0.2.0-1 stored in tensor folder instance 440C. In an implementation, manifest entry 335C includes a reference to the storage location of chunk 0.2.0-1. In this example, no new versions of chunk 0.1.0 is received, so manifest entry 330C is not changed from manifest entry 330B in manifest version 320B. Implementation examples of tensor folders are described with FIG. 5 below.

FIG. 5 is an example code 500 that can facilitate storing tensor data using differential snapshots, in accordance with one or more embodiments. For purposes of brevity, description of like elements and/or processes employed in other embodiments is omitted. As depicted, directories 502 and 506 and example manifest file 504 illustrates example file system implementations of one or more embodiments.

In an example, manifest versions 540 refer to respective manifest versions 320A-C, with entries that reference the location and access information for data chunks stored in the file directory with manifest versions 540, or in other file system locations. For example, chunks 560A-C refer to respective entries in one or more of manifest versions 540. In manifest 520 (e.g., one of manifest versions 540), chunks 560A-C respectively reference a filename and hash value for three different chunks of pic-5-22-12 in manifest. version-1, e.g., 3.1.0, 3.1.1, and 3.1.2.

In one or more embodiments, chunks 560A-C may be stored in a subdirectory of the file directory containing manifest versions 540, e.g., pic-5-22-12. The contents of directory 570, referenced by manifest versions 540 and entries corresponding to chunk 560A, are shown to be individual files the correspond to chunks.

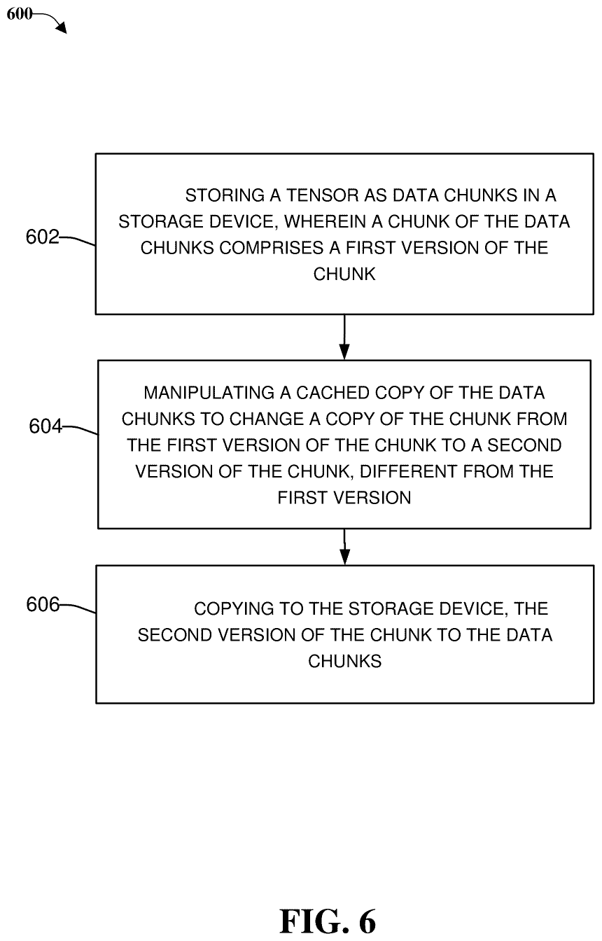

FIG. 6 depicts a flow diagram representing example operations of an example method 600 that can facilitate storing tensor data using differential snapshots, in accordance with one or more embodiments. For purposes of brevity, description of like elements and/or processes employed in other embodiments is omitted.

In some examples, one or more embodiments of method 600 can be implemented by storing component 122, tensor modifying component 124, tensor snapshot component 126, and other components that can be used to implement aspects of method 600, in accordance with one or more embodiments. It is appreciated that the operating procedures of method 600 are example operating procedures, and that there can be embodiments that implement more or fewer operating procedures than are depicted, or that implement the depicted operating procedures in a different order than as depicted.

At 602 of method 600, storing component 122 of model training equipment 150 can, in one or more embodiments, store a tensor as data chunks in a storage device, wherein a chunk of the data chunks comprises a first version of the chunk. At 604 of method 600, tensor modifying component 124 can, in one or more embodiments, manipulate a cached copy of the data chunks to change a copy of the chunk from the first version of the chunk to a second version of the chunk, different from the first version. At 606 of method 600, tensor snapshot component 126 can, in one or more embodiments, copy to the storage device, the second version of the chunk to the data chunks.

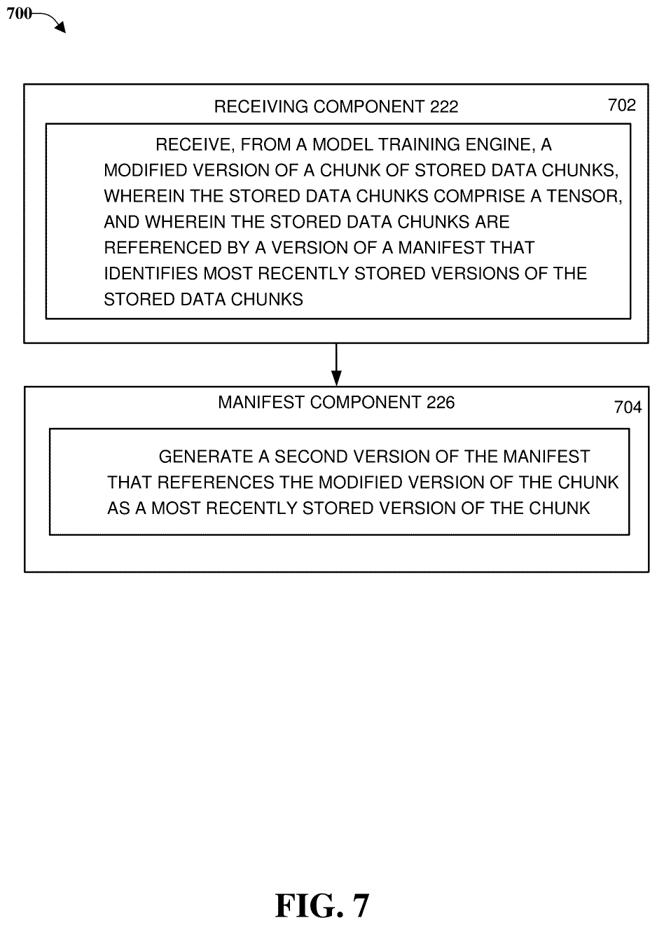

FIG. 7 depicts an example system 700 that can facilitate storing tensor data using differential snapshots, in accordance with one or more embodiments. For purposes of brevity, description of like elements and/or processes employed in other embodiments is omitted.

Example system 700 can include receiving component 222, manifest component 226, and other components that can be used to implement aspects of system 700, as described herein, in accordance with one or more embodiments. At 702 of FIG. 7, receiving component 222 can receive, from a model training engine, a modified version of a chunk of stored data chunks, wherein the stored data chunks comprise a tensor, and wherein the stored data chunks are referenced by a first version of a manifest that identifies most recently stored versions of the stored data chunks. At 704 of FIG. 7, manifest component 226 can generate a second version of the manifest that references the modified version of the chunk as a most recently stored version of the chunk.

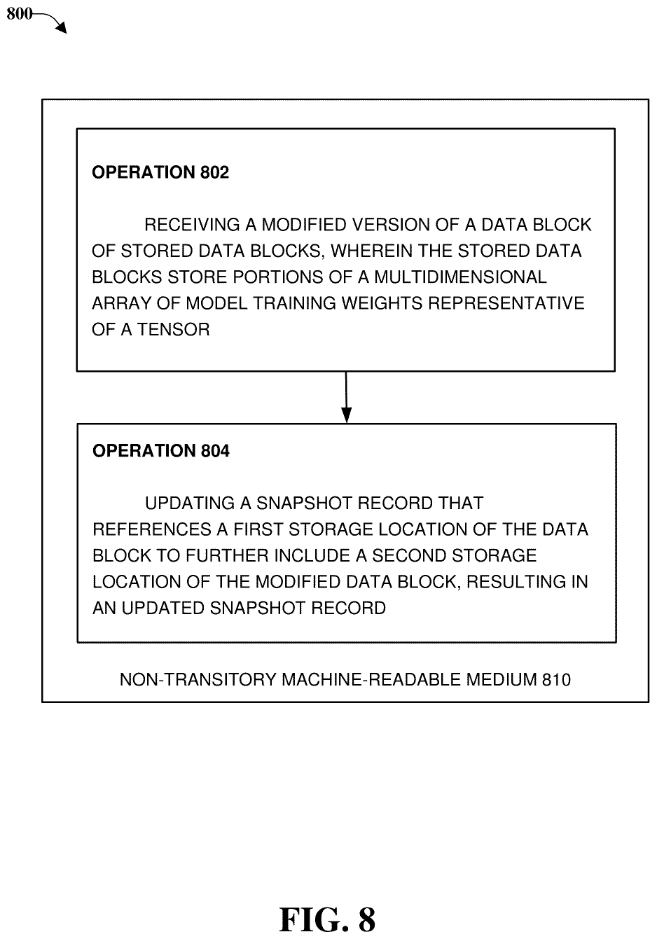

FIG. 8 depicts an example 800 non-transitory machine-readable medium 810 that can include executable instructions that, when executed by a processor of a system, can facilitate storing tensor data using differential snapshots, in accordance with one or more embodiments. For purposes of brevity, description of like elements and/or processes employed in other embodiments is omitted.

As depicted, non-transitory machine-readable medium 810 includes comprising executable instructions that, when executed by at least one processor of a data loading device, facilitate performance of operations that include operation 802 which, in one or more embodiments includes receiving a modified version of a data block of stored data blocks, wherein the stored data blocks store portions of a multidimensional array of model training weights representative of a tensor.

The operations may further include operation 804 which, in one or more embodiments includes updating a snapshot record that references a first storage location of the data block to further include a second storage location of the modified data block, resulting in an updated snapshot record.

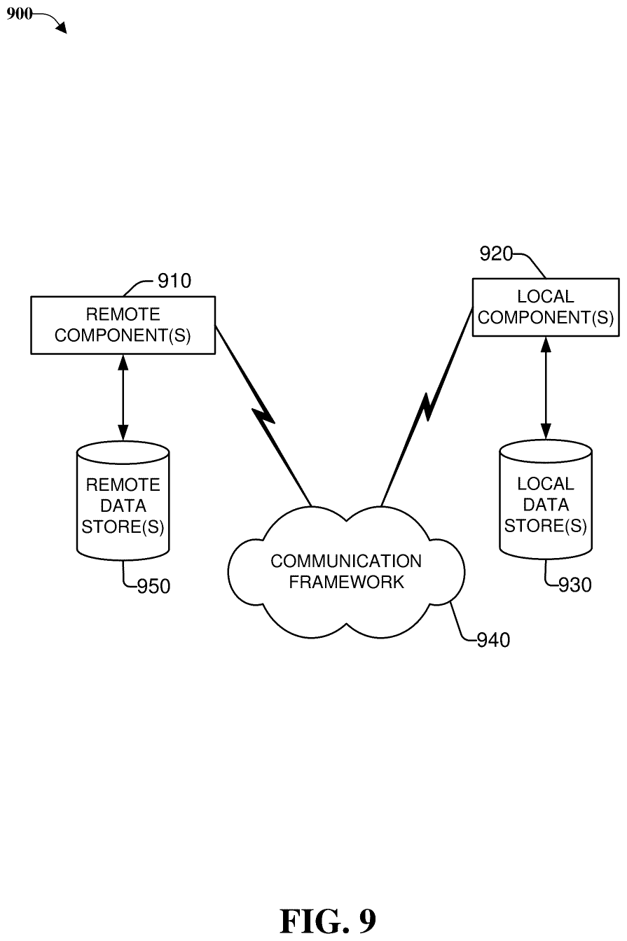

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP 2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computing system, comprising:
at least one memory that stores computer executable instructions; and
at least one processor configured to process the computer executable instructions that, when executed by the at least one processor, facilitate performance of operations, comprising:
receiving, from a model training engine, a modified version of a data chunk of stored data chunks, wherein the stored data chunks comprise a tensor, and wherein the stored data chunks are referenced by a first version of a manifest that identifies a most recently stored version of the data chunk with a corresponding first hash value,
based on the modified version of the data chunk, generating a second hash value different from the first hash value,
generating a second version of the manifest that references the modified version of the data chunk with a second hash value comprising an entry comprised in the manifest, and
based on a comparison of the first version of the manifest and the second version of the manifest, generating data corresponding to a snapshot differences report for a snapshot of changes to the tensor over time, wherein the snapshot differences report is representative of a difference between first text of the first hash value and second text of the second hash value.

2. The computing system of claim 1, wherein the operations further comprise:
receiving a request to input the tensor to the model training engine,
based on the second version of the manifest, selecting the most recently stored version of the data chunk, and
based on the most recently stored version of the data chunk, inputting the tensor to the model training engine.

3. The computing system of claim 2, wherein the modified version of the data chunk of stored data chunks is received from the training engine based on a checkpoint operation.

4. The computing system of claim 3, wherein the request to input the tensor to the model training engine comprises a request to input data from the checkpoint operation.

5. The computing system of claim 1, wherein the second version of the manifest further references a stored version of another chunk of the stored data chunks as a most recently created version of the other chunk.

6. The computing system of claim 1, wherein the first version of the manifest and the second version of the manifest are respectively comprised in a first file system file of a file system and a second file system file of the file system.

7. The computing system of claim 6, wherein the second file system file comprises entries referencing the data chunks of the tensor, and wherein the entries comprise references to most recent version of the data chunk.

8. The computing system of claim 6, wherein the data chunks, the first file system file, and the second file system file are stored in a directory of the file system.

9. The computing system of claim 1, wherein the operations further comprise, based on the second version of the manifest, generating version tracking data for the tensor.

10. (canceled)

11. A method, comprising:
storing, by a system comprising at least one processor, a tensor as data chunks in a storage device, wherein a chunk of the data chunks comprises a first version of the chunk, wherein a first version of a manifest references the first version of the chunk with a corresponding first hash value;
manipulating, by the system, a cached copy of the data chunks to change a copy of the chunk from the first version of the chunk to a second version of the chunk, different from the first version of the chunk; and
generating a second version of the manifest that references the second version of the chunk with a second hash value different from the first hash value;
based on a comparison of the first version of the manifest and the second version of the manifest, generating data corresponding to a snapshot differences report representative of a difference between the first hash value and the second hash value; and
copying, by the system, to the storage device, the second version of the chunk to the data chunks.

12. The method of claim 11, further comprising, before the copying of the second version of the chunk, based on the snapshot differences report, identifying, by the system, that the second version of the chunk is different from the first version of the chunk, and
copying, by the system, the second version of the chunk based on the identifying.

13. The method of claim 11, further comprising, receiving, by the system, a request to perform a checkpoint operation on a process of manipulating the data chunks, wherein copying the second version to the data chunks comprises the checkpoint operation, which comprises the change to the copy of the chunk.

14. The method of claim 11, wherein the system comprises a model training system that utilizes tensors to train a machine learning model.

15. The method of claim 11, further comprising, receiving, by the system, from a raw data processing engine, the tensor, wherein the tensor was generated by a transformation of raw data.

16. A non-transitory machine-readable medium comprising executable instructions that, when executed by at least one processor of a data loading device, facilitate performance of operations, the operations comprising:
receiving a modified version of a data block of stored data blocks, wherein the stored data blocks store portions of a multidimensional array of model training weights representative of a tensor; and
updating a snapshot record that references a first storage location of the data block with a first hash value to further include a second storage location of the modified data block with a second hash value different than the first hash value, resulting in an updated snapshot record.

17. The non-transitory machine-readable medium of claim 16, wherein the receiving of the modified version of the data block comprises receiving the modified version from a training backend that generated the modified version by transforming source data of the multidimensional array to modify a portion of the multidimensional array corresponding to the data block.

18. The non-transitory machine-readable medium of claim 16, wherein the operations further comprise:
comparing the text snapshot record to the updated snapshot record to identify the modified version of the data block, resulting in a snapshot update of the multidimensional array; and
communicating, to a compute node that uses the multidimensional array as training data, the snapshot update of the multidimensional array.

19. The non-transitory machine-readable medium of claim 16, wherein the receiving of the modified version of the data block comprises receiving the modified version from a compute node that generated the modified version of the data block based on a modification of a model weight stored in the multidimensional array.

20. The non-transitory machine-readable medium of claim 16, wherein the operations further comprise:
analyzing the snapshot record and the updated snapshot record; and
based on the analyzing, generating a version tracking report for the multidimensional array, wherein the version tracking report identifies that second hash value is different from the first hash value.

21. The non-transitory machine-readable medium of claim 16, wherein the snapshot record and the updated snapshot record are respectively comprised in a first file system file of a file system and a second file system file of the file system.
